(19) United States
(12) Patent Application Publication
(10) Pub. No.: US 2023/0289659 A1
(43) Pub. Date: Sep. 14, 2023

(54) NON-TRANSITORY RECORDING MEDIUM, INFORMATION PROCESSING DEVICE AND INFORMATION PROCESSING METHOD

(71) Applicant: Fujitsu Limited, Kawasaki-shi (JP)

(72) Inventors: Takashi KATOH, Kawasaki (JP); Kento UEMURA, Kawasaki (JP); Suguru YASUTOMI, Kawasaki (JP)

(73) Assignee: Fujitsu Limited, Kawasaki-shi (JP)

(21) Appl. No.: 18/174,625

(22) Filed: Feb. 26, 2023

(30) Foreign Application Priority Data
Mar. 8, 2022 (JP) 2022-035575

(51) Int. Cl. G06N 20/00

(52) U.S. Cl. CPC G06N 20/00

(57) ABSTRACT

An information processing method comprising: for a classification model for classifying input data into one or another of plural classes that was trained using a first data set, identifying, in a second data set that is different from the first data set one or more items of data having a specific datum of which a degree of contribution to a change in a classification criterion is greater than a predetermined threshold, the classification criterion being a classification criterion of the classification model during re-training based on the second data set; and, from among the one or more items of data, detecting an item of data, for which a loss reduces for the classification model by change to the classification criterion by re-training based on the second data set, as an item of data of an unknown class not contained in the plural classes.

### CROSS-REFERENCE TO RELATED APPLICATION

This application is based upon and claims the benefit of priority of the prior Japanese Patent Application No. 2022-035575, filed on Mar. 8, 2022, the entire contents of which are incorporated herein by reference.

### FIELD

The embodiments discussed herein are related to a non-transitory storage medium stored with an information processing program, an information processing device, and an information processing method.

### BACKGROUND

In a known technology called open set recognition, data items that are contained in data input to a classification model for classifying input data into one or another of plural classes but that was not contained in training data employed for training are detected as items of data of an unknown class. An example of a conceivable application of this technology is, for example, to return an error in cases in which an item of data of a class not contained in the training data has been input to a classification model, and to interrupt processing prior to a more serious problem occurring due to misdetection by the classification model. Another conceivable possible application is to generate a dedicated classification model by dividing data into trained classes and untrained classes, and performing labeling of items of data only in the untrained classes, so as to implement sequential learning.

As technology related to open set recognition, for example, there is a proposal for an information processing device that determines whether or not new item of target data is an item of target data of an unknown classification. This information processing device generates feature data by extracting features from new target data items. This information processing device also takes an assembly of target data items built up from already classified target data items and new target data items, and then performs clustering thereon based on the feature data of the already classified target data items and new target data items, so as to cluster into a number of clusters that is the number of classifications when the classified target data were classified+1. Such an information processing device performs a query output regarding a new classification of target data in cases in which there is a cluster in the clustering result that appears only in the new target data.

### RELATED PATENT DOCUMENTS

International Publication (WO) No. 2018/122931

### SUMMARY

According to an aspect of the embodiments, a non-transitory recording medium is stored with a program that causes a computer to execute a processing process. The process includes: for a classification model for classifying input data into one or another of plural classes that was trained using a first data set, identifying, in a second data set that is different from the first data set one or more items of data having a specific datum of which a degree of contribution to a change in a classification criterion is greater than a predetermined threshold, the classification criterion being a classification criterion of the classification model during re-training based on the second data set; and from among the one or more items of data, detecting an item of data, for which a loss reduces for the classification model by change to the classification criterion by re-training based on the second data set, as an item of data of an unknown class not contained in the plural classes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of an information processing device.

FIG. 2 is a diagram to explain open set recognition.

FIG. 3 is a diagram to explain a case in which data of an unknown class is detected based on change to a classification model between before and after re-training.

FIG. 4 is a diagram to explain issues arising in cases in which data of an unknown class is detected based on change to a classification model between before and after re-training.

FIG. 5 is a diagram to explain an outline of an exemplary embodiment.

FIG. 6 is a diagram to explain a classification model.

FIG. 7 is a diagram to explain computation of loss.

FIG. 8 is a diagram to explain computation of an update value for a weight.

FIG. 9 is a diagram to explain computation of a movement distance.

FIG. 10 is a diagram to explain detection of data of an unknown class.

FIG. 11 is a block diagram illustrating a schematic configuration of a computer that functions as an information processing device.

FIG. 12 is a flowchart illustrating an example of information processing.

FIG. 13 is a diagram to explain a specific example of information processing.

FIG. 14 is a diagram to explain a specific example of information processing.

FIG. 15 is a diagram to explain a specific example of information processing.

FIG. 16 is a diagram to explain a specific example of information processing.

FIG. 17 is a diagram to explain a specific example of information processing.

FIG. 18 is a diagram to explain a specific example of information processing.

FIG. 19 is a diagram to explain a specific example of information processing.

### DESCRIPTION OF EMBODIMENTS

Explanation follows regarding an example of an exemplary embodiment according to technology disclosed herein, with reference to the drawings.

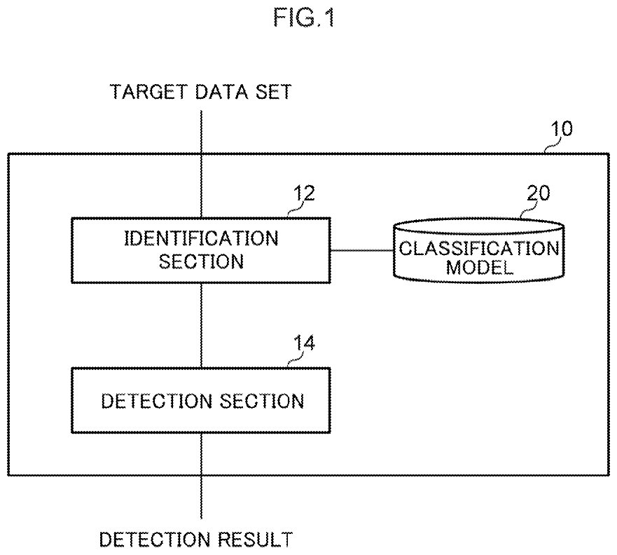

As illustrated in FIG. 1, a classification model 20 that has been trained by machine learning to classify input data into one or another of plural classes is stored in an information processing device 10 according to the present exemplary embodiment. The classification model 20 is a model trained using a training data set. A target data set different to the training data set is input to the information processing device 10. The target data set may, for example, be a data set input at a time of application of a system utilizing the classification model 20. The information processing device 10 detects data in the target data set of a class not contained in the training data set, i.e. of a so-called unknown class, and outputs a detection result. The training data set is an example of a first data set of technology disclosed herein, and the target data set is an example of a second data set of technology disclosed herein.

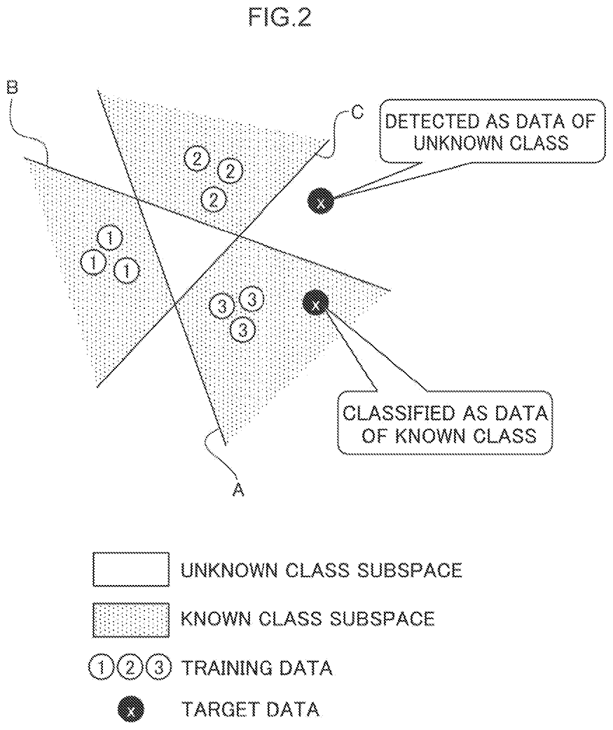

Explanation follows regarding a general method of open set recognition. As illustrated in FIG. 2, in open set recognition, training data is projected onto feature space, and the feature space is divided into plural subspaces. Generation and division of the feature space is often realized by combining plural binary classifiers using known class labels or the like. In the example of FIG. 2, the feature space is divided based on the training data using a boundary dividing between class 1 and classes 2 and 3 (indicated by A in FIG. 2), a boundary dividing between class 2 and classes 1 and 3 (indicated by B in FIG. 2), and a boundary dividing between class 3 and classes 1 and 2 (indicated by C in FIG. 2). The portions indicated by shading in FIG. 2 are subspaces of known classes, and the unshaded portions are subspaces of unknown classes. At the time of application, target data not belonging to a subspace of any of the known classes is detected as being data of an unknown class.

In a general method of open set recognition such as described above, when generating the classification model there is an expectation that an unknown class will be input at the time of application, and that there is a need to train the classification model using a special method. Moreover, in cases in which data of an unknown class is contained in application data, conceivably a classification model generated by normal training not anticipating the unknown class might be re-used, and the classification model re-trained. However, sometimes the training data set is not available at the time of application of the classification model, due to the training data set having been returned or the like. In such cases, re-training of the classification model is not able to be executed due to not being able to determine which items of data is in an unknown class from among the target data items contained in the target data set at the time of application.

A conceivable approach in cases in which a classification model trained on a training data set is available, but the training data set is not available, might be to detect data of an unknown class in the target data set based on the classification model and on the target data set.

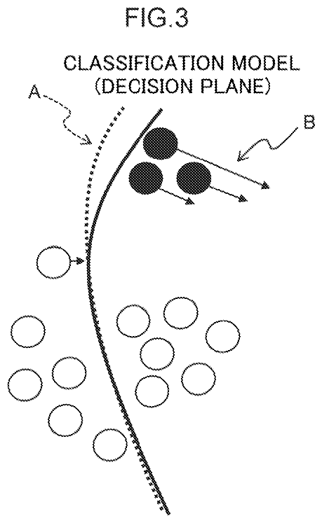

For example as illustrated in FIG. 3, in cases in which a classification model has been re-trained with a target data set, there is a high possibility of there being a large difference between the training data set and the target data set in cases in which a large change occurs for a decision plane indicating a boundary between classes in the classification model before and after re-training. As illustrated at A in FIG. 3, an estimate is made of how much the classification model seems to change by re-training. More specifically, whether or not the classification model changes by re-training is determined using an index indicating the effect a loss for the target data set imparts to a weight of the current classification model. As illustrated at B in FIG. 3, target data having a large movement distance might conceivably be detected as being data of an unknown class in cases in which individual items of target data are moved under the consideration of eliminating change that occurs to the classification model by re-training.

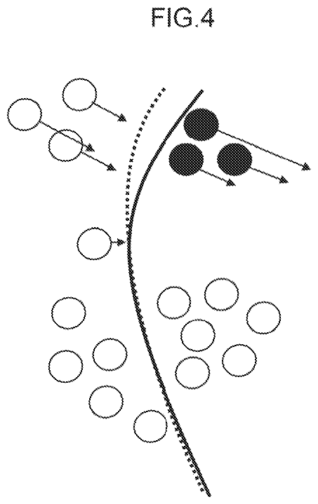

However, in cases in which the target data items are moved so as to eliminate change to the classification model, as illustrated in FIG. 4, sometimes the movement distance is large not only for items of data actually of an unknown class (indicated by solid black circles in FIG. 4), but also for items of target data of a known class in the vicinity of a greatly changed portion of the classification model. The items of data of an unknown class are not able to be detected with good accuracy in such circumstances.

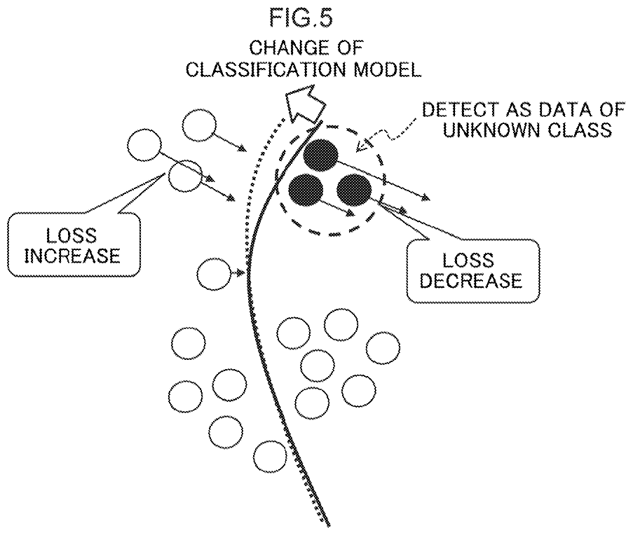

To address this issue, in the present exemplary embodiment, items of data of an unknown class are detected based on differences in properties exhibited by the items of target data with respect to change in the classification model during re-training with the target data set. More specifically, as illustrated in FIG. 5, items of data having a property (1) and items of data having a property (2), as set out below, are both present among the items of target data containing items of data of an unknown class. Note that the loss described below is a value that increases the closer the distance between an item of target data and a decision plane.
(1) Data for which loss is increased by change to the classification model (data with increased loss when moved in a direction to suppress change to the classification model)
(2) Data for which loss is decreased by change to the classification model
(data with decreased loss when moved in a direction to suppress change to the classification model)

The items of data of an unknown class are items of data having the above property (2). This insight is utilized in the present exemplary embodiment to detect the data of an unknown class with good accuracy. Detailed explanation follows regarding functional sections of an information processing device according to the present exemplary embodiment.

The information processing device 10 includes, from a functional perspective, an identification section 12 and a detection section 14, as illustrated in FIG. 1.

The identification section 12 identifies one or more item of target data from a target data set that, when re-training based on the target data set, is target data having a degree of contribution of a specific datum or greater to a change in weight for identifying a decision plane of the classification model 20. Note that the weight is an example of a classification criterion of technology disclosed herein. Specifically, the identification section 12 computes, as the degree of contribution, a movement distance when each item of target data contained in the target data set is moved so as to reduce an update value of the weight of the classification model 20 when re-training based on the target data set.

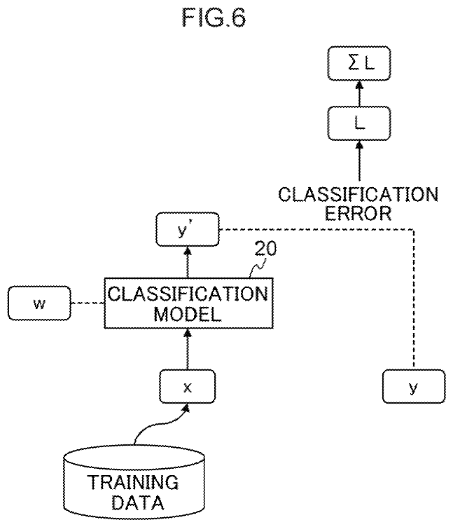

More specifically, as illustrated in FIG. 6, the classification model 20 optimizes a weight w so as to minimize a sum ΣL of loss L when each item of training data contained in the training data set has been input to the classification model 20 as input data x. The loss L is a classification error between an output y′ of the classification model 20, and a correct label y appended to the training data.

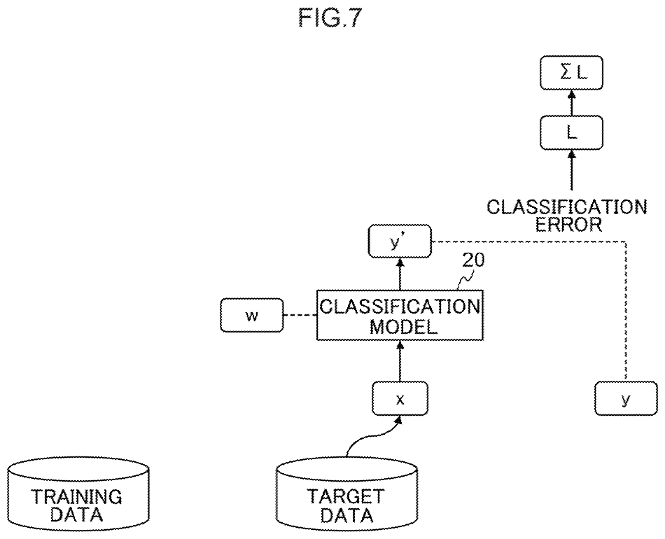

As illustrated in FIG. 7, the identification section 12 computes the sum ΣL of loss L, which is the classification error between the output y′ and the correct label y when each item of target data contained in the target data set has been input as input data x to the classification model 20. The identification section 12 may employ a label based on the output y′ as the correct label y for the target data. More specifically, the output y′ is a probability that the input data belongs to each class classifiable by the classification model 20. When such an approach is adopted, the identification section 12 may take the label of the class having the maximum probability as indicated by output y′ for the target data (input data x) as being the correct label y for this item of target data.

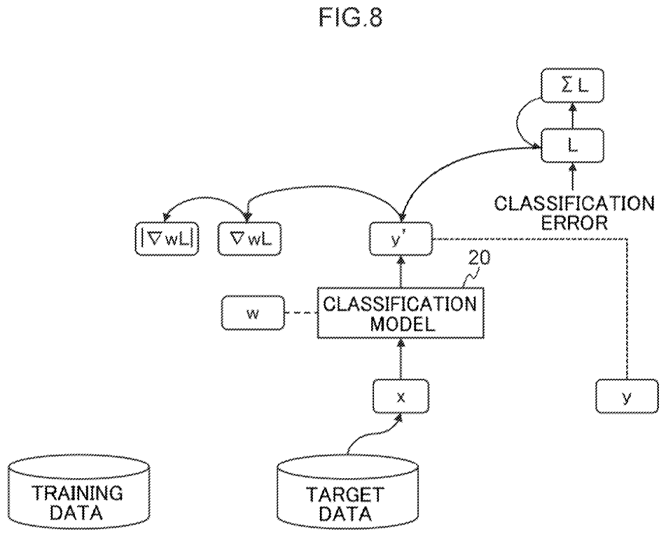

Moreover, the identification section 12 computes an update value |Δw| of a weight with respect to the loss sum ΣL as an index expressing change to the classification model 20. The identification section 12 may also compute, as the update value in cases in which the classification model 20 is a differentiable model such as a neural network, a gradient magnitude indicating the effect a loss imparts to the weight of the classification model 20 for the target data. More specifically as illustrated in FIG. 8, the identification section 12 uses backpropagation to find a gradient ∇wL with respect to the loss sum ΣL of the weight w of the classification model 20, and computes a gradient magnitude |∇wL|.

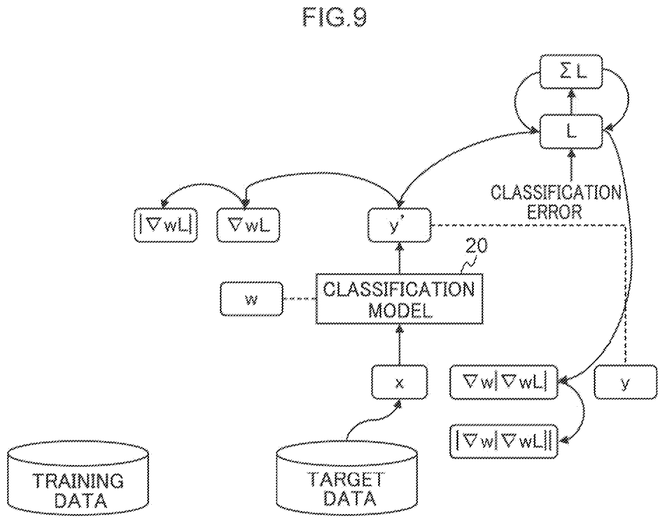

Moreover, as the degree of contribution to change of the classification model 20 during re-training with the target data set, the identification section 12 takes a movement distance |Δx| of the target data for a case in which the individual items of the target data (input data x) are moved to reduce the update value of the weight |Δw|. The identification section 12 then identifies any items of target data for which the movement distance is a predetermined threshold or greater. In cases in which the classification model 20 is a differentiable model, the identification section 12 may compute a magnitude of gradient for each item of target data with respect to the magnitude of gradient of the weight with respect to the loss, as the movement distance. Specifically as illustrated in FIG. 9, for each of the items of target data the identification section 12 computes a gradient ∇x|∇wL| of the target data (input data x) with respect to the gradient magnitude |VwL|, and a magnitude |∇x|∇wL| thereof. Backpropagation (double backpropagation) may be applied for this computation.

The detection section 14 detects, as being data of an unknown class, any items of target data, from among the one or more data items identified by the identification section 12, for which the loss decreases for the classification model 20 by change in weight due to being re-trained based on the target data set. Specifically, the detection section 14 detects, as being data of an unknown class, any items of target an item of data having a positive increase amount of loss in cases in which the one or more identified items of target data are moved in directions to suppress change to the classification model 20 from re-training.

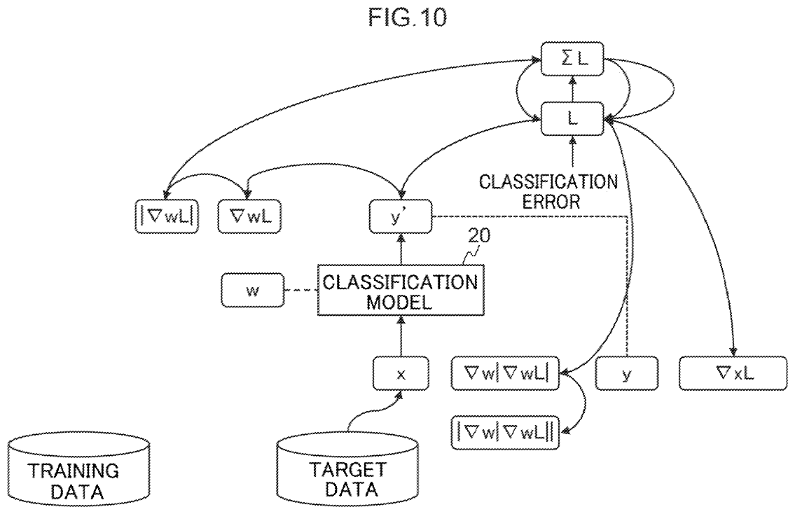

More specifically as illustrated in FIG. 10, the detection section 14 uses backpropagation to find a gradient ∇xL of the target data (input data x) with respect to the loss sum ΣL. The detection section 14 then, from among the target data identified by the identification section 12, detects any items of target data for which the gradient ∇x|∇wL| and gradient ∇xL are positive as being data of an unknown class. The identification section 12 may detect any items of target data for which the inner product between the gradient ∇x|∇wL| and the gradient ∇xL is positive as being data of an unknown class. The detection section 14 outputs the detected items of data of an unknown class as a detection result.

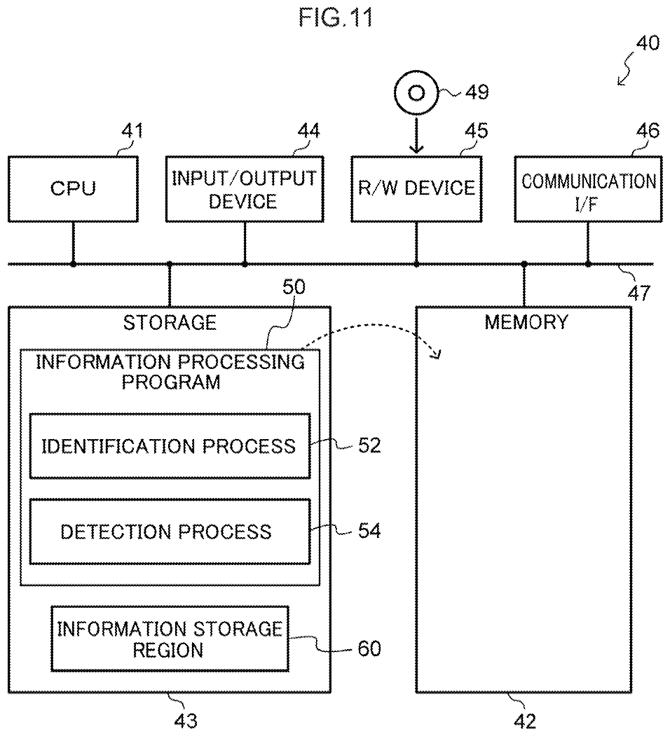

The information processing device 10 may, for example, be implemented by a computer 40 as illustrated in FIG. 11. The computer 40 is equipped with a central processing unit (CPU) 41, memory 42 serving as temporary storage space, and a non-transitory storage section 43. The computer 40 also includes an input/output device 44 such an input section, display section, and the like, and a read/write (R/W) section 45 to control reading data from a storage medium 49 and writing data thereto. The computer 40 also includes a communication interface (I/F) 46 connected to a network such as the Internet. The CPU 41, the memory 42, the storage section 43, the input/output device 44, the R/W section 45, and the communication I/F 46 are mutually connected together through a bus 47.

The storage section 43 may, for example, be implemented by a hard disk drive (HDD), solid state drive (SSD), or flash memory. The storage section 43 serves as a storage medium stored with an information processing program 50 that causes the computer 40 to function as the information processing device 10. The information processing program 50 includes an identification process 52 and a detection process 54. The storage section 43 also includes an information storage region 60 stored with information configuring the classification model 20.

The CPU 41 reads the information processing program 50 from the storage section 43, expands the information processing program 50 in the memory 42, and sequentially executes the processes included in the information processing program 50. By executing the identification process 52, the CPU 41 acts as the identification section 12 illustrated in FIG. 1. By executing the detection process 54, the CPU 41 acts as the detection section 14 illustrated in FIG. 1. The CPU 41 also reads information from the information storage region 60 and expands the classification model 20 in the memory 42. The computer 40 executing the information processing program 50 thereby functions as the information processing device 10. Note that the CPU 41 executing the program is hardware.

Note that the functions implemented by the information processing program 50 may also be implemented by, for example, a semiconductor integrated circuit, and more specifically by an application specific integrated circuit (ASIC).

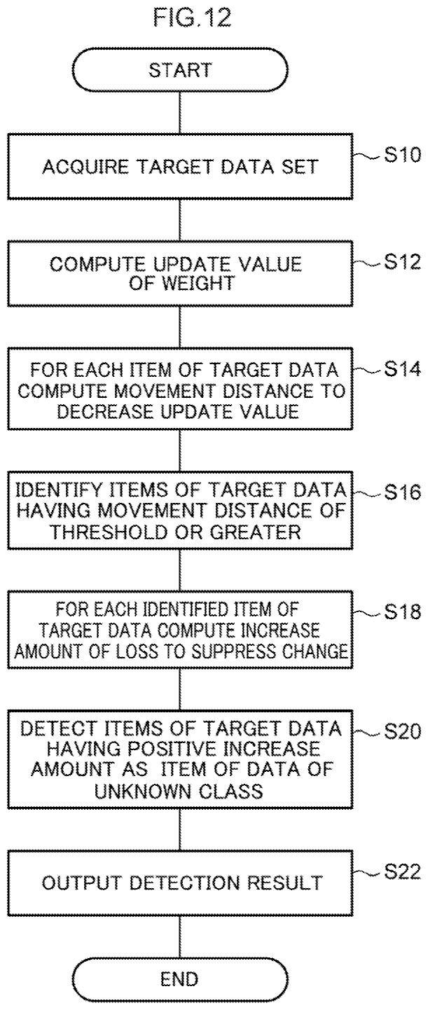

Next, description follows regarding operation of the information processing device 10 according to the present exemplary embodiment. The classification model 20 trained by machine learning using the training data set is stored in the information processing device 10, and the information processing illustrated in FIG. 12 is executed in the information processing device 10 when the target data set is input to the information processing device 10. Note that the information processing is an example of an information processing method of technology disclosed herein.

At step S10 the identification section 12 acquires the target data set input to the information processing device 10. Then at step S12, the identification section 12 labels the target data based on the output obtained by inputting each of the items of target data contained in the target data into the classification model 20. The identification section 12 then computes a sum of losses, which are classification errors between the output when each of the items of target data contained in the target data was input to the classification model 20 and their respective correct labels, and computes an update value for the weight of the classification model 20 with respect to the loss sum.

Next, at step S14, the identification section 12 computes movement distances when each of the items of target data contained in the target data set is moved so as to reduce the computed update value of the weight. Next, at step S16 the identification section 12 identifies any items of target data having a computed movement distance that is the specific threshold or greater. This threshold may be a predetermined value, and may be a value dynamically determined so as to detect specific individual items of target data in sequence from the greatest movement distance.

Next, at step S18, the detection section 14 computes an increase amount of the loss when each of the identified items of target data has been moved in a direction to suppress change to the classification model 20 by re-training. Next, at step S20, the detection section 14 detects target data for which the increase amount of the computed loss is positive as being data of an unknown class. Next, at step S22, the detection section 14 outputs the detection result and ends the information processing.

Next, a more specific description will be given regarding the information processing using simple examples thereof.

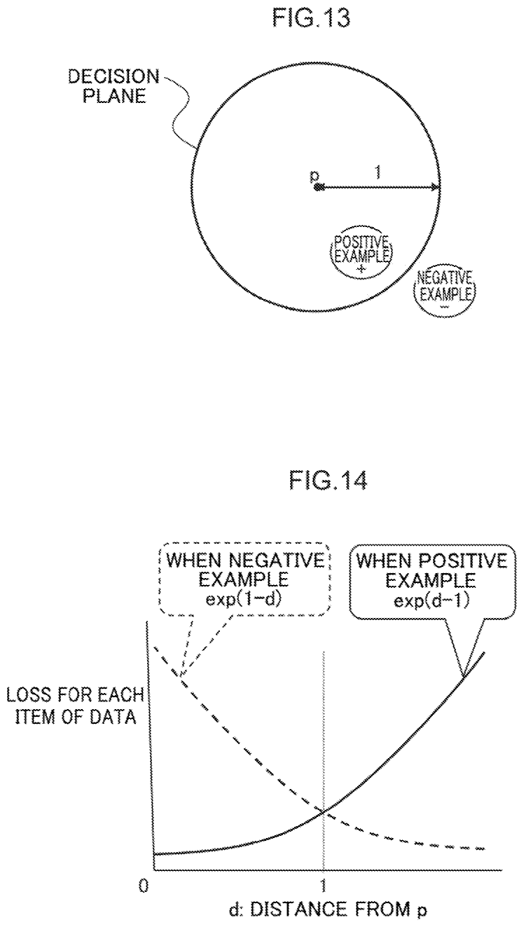

As illustrated in FIG. 13, say a plane for which a distance is 1 from a point p=(x, y) on a two dimensional plane is employed as a decision plane, and a model that classifies data having a distance from p of less than 1 as a positive example and data having a distance therefrom of 1 or greater as a negative example is taken as the classification model 20. Training of the classification model 20 is performed so as to minimize the following loss sum ΣL.

ΣL=Σi exp((∥p−aᵢ∥−1)cᵢ)/N

Wherein aᵢ is two dimensional coordinates of an i^{th} item of training data, cᵢ is a label of the i^{th} item of training data (positive example: 1, negative example: −1), and N is the number of items of training data contained in the training data set. FIG. 14 illustrates a loss for each item of training data corresponding to a distance d from p.

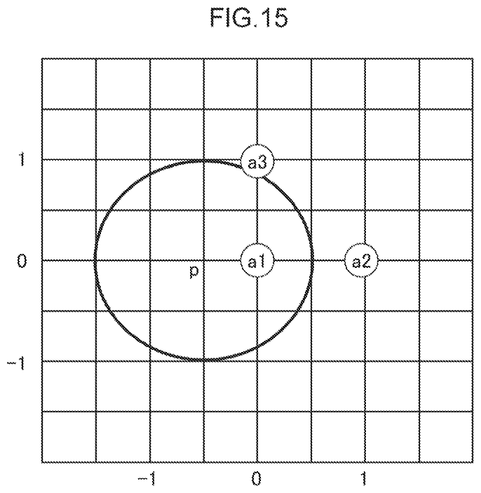

The weight of this classification model 20 is p. As illustrated in FIG. 15, say that p optimized by machine learning using the training data set is (−0.5, 0.0). Say the following items of target data a1, a2, and a3 are contained in the target data set.

a1=(0.0, 0.0)

a2=(1.0, 0.0)

a3=(0.0, 1.0)

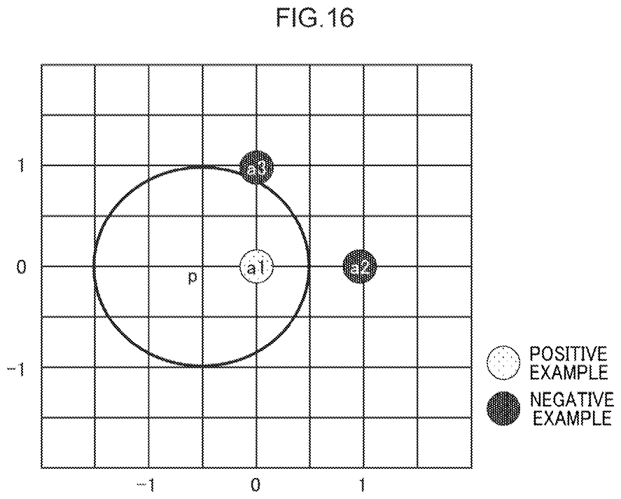

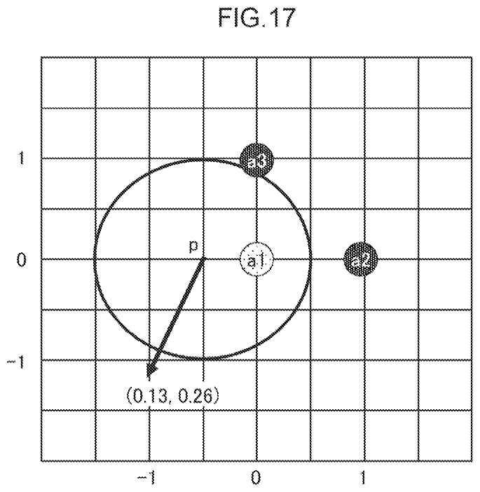

In such cases, as illustrated in FIG. 16, the label positive example is appended to a1, and the label negative example is appended to a2 and a3. The identification section 12 computes a magnitude of gradient of the weight p ∥(0.13, 0.26∥=0.30 as an update value of weight p with respect to loss L in cases in which these items of target data have been input to the classification model 20. As illustrated in FIG. 17, the gradient of weight p is a vector expressing a direction and magnitude by which p seeks to change in cases in which the classification model 20 is re-trained using the target data. Note that the arrow in FIG. 17 illustrates—5 times the gradient. The identification section 12 then computes the gradient of each item of target data and the magnitude thereof with respect to the magnitude of the gradient of weight p, as set out below.

a1: ∥(−0.09, −0.36)∥=0.37

a2: ∥(−0.09, 0.12)∥=0.15

a3: ∥(−0.13, −0.26)∥=0.30

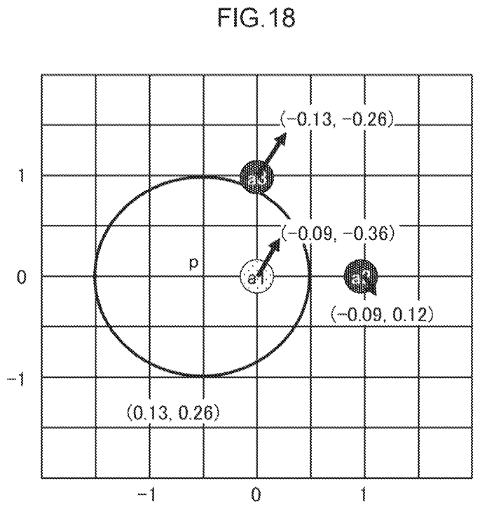

As illustrated in FIG. 18, the gradient of each item of target data with respect to the magnitude of gradient of weight p is a vector expressing a direction and magnitude by which the item of target data seeks to move in cases in which a change in p is suppressed. Note that the arrows in FIG. 18 illustrate −3 times the gradient. Say there is a threshold=0.2 in such cases, for example, then the identification section 12 identifies the target data a1 and a3 as being candidates for data of an unknown class.

The detection section 14 computes a gradient of each item of target data with respect to loss L as indicated below.

a1=(0.20, 0.00)

a2=(−0.20, 0.00)

a3=(−0.13, −0.26)

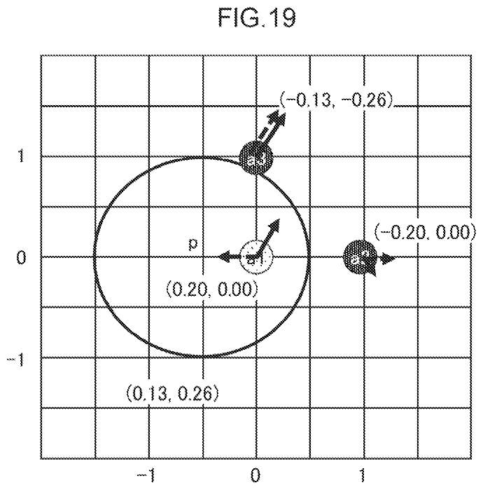

As illustrated in FIG. 19, the gradient of each item of target data with respect to the loss L is a vector expressing a direction and magnitude by which an item of target data seeks to move so as to make the loss smaller. Note that the arrows in FIG. 19 illustrate −3 times the gradient. Moreover, the target data a2 that is not a candidate for data of an unknown class is also indicated together in FIG. 19.

For each candidate for data of an unknown class, the detection section 14 then computes an inner product between the gradient of each item of target data with respect to the magnitude of gradient of weight p and the gradient of each item of target data with respect to the loss L.

a1=(−0.09, −0.36)·(0.20, 0.00)=−0.0180

a3=(−0.13, −0.26)·(−0.13, −0.26)=0.085>0

In such cases the detection section 14 detects the target data a3 having a positive inner product as being data of an unknown class. This thereby enables items of data that have a large degree of contribution to change in the classification model 20 when re-training with the target data set, and that are also items of data for which the loss is reduced by change to the classification model 20, i.e. data with the above property (2), to be detected as being data of an unknown class.

As described above, the information processing device according to the present exemplary embodiment identifies in the target data set one or more items of data having the specific datum or greater as the degree of contribution to change when the classification model trained using the training data set is re-trained based on the target data set. The information processing device then, from among the one or more items of identified data, detects any data for which the loss is reduced by change to the classification model as being data of an unknown class. This thereby enables items of data of an unknown class in a classification model to be detected from the target data set even in cases in which the training data set is no longer available.

Note that although for the above exemplary embodiment a mode has been described in which the information processing program is pre-stored (installed) in the storage section, there is no limitation thereto. The program according to the technology disclosed herein may be provided in a format stored on a storage medium, such as a CD-ROM, DVD-ROM, USB memory, or the like.

Sometimes the training data that was used in machine learning of a classification model is no longer available at the time of application of the classification model trained by machine learning. For example, in a business situation using customer data, there are often cases in which the prolonged retention of data from a given customer, or the re-use of a classification model trained by machine learning using a given customer's data for a task with another customer, is no allowed from contractual and data breach risk perspectives. After machine learning of the classification model has been performed, sometimes the training data is returned and the classification model alone is retained. In such circumstances, data of an unknown class is unable to be detected from the data set at the time of application using the method of the related technology.

The technology disclosed herein enables data of an unknown class in the classification model to be detected from the target data even in cases in which the training data set is no longer available.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a program that causes a computer to execute a process, the process comprising:
for a classification model for classifying input data into one or another of a plurality of classes that was trained using a first data set, identifying, in a second data set that is different from the first data set, one or more items of data having a specific datum of which a degree of contribution to a change in a classification criterion is greater than a predetermined threshold, the classification criterion being a classification criterion of the classification model during re-training based on the second data set; and
from among the one or more items of data, detecting an item of data, for which a loss reduces for the classification model by change to the classification criterion by re-training based on the second data set, as an item of data of an unknown class not contained in the plurality of classes.

2. The non-transitory recording medium of claim 1, wherein the classification criterion is a weight to identify a decision plane indicating a boundary between classes in the classification model.

3. The non-transitory recording medium of claim 1, wherein a movement distance, when each of the items of data contained in the second data set is moved so as to reduce an update value of the classification criterion of the classification model during re-training based on the second data set, is computed as the degree of contribution.

4. The non-transitory recording medium of claim 1, wherein an item of data having a positive increase amount of the loss when each of the one or more items of data is moved in a direction to suppress change of the classification criterion by re-training based on the second data set is detected as the item of data of an unknown class.

5. The non-transitory recording medium of claim 3, wherein, when the classification model is a differentiable model, a magnitude of a first gradient of the classification criterion with respect to the loss is computed as the update value, and a magnitude of a second gradient of each of the items of data contained in the second data set with respect to the magnitude of the first gradient is computed as the movement distance.

6. The non-transitory recording medium of claim 5, wherein an item of data having a positive inner product between the second gradient and a third gradient of each of the one or more items of data with respect to the loss is detected as being the item of data of an unknown class.

7. The non-transitory recording medium of claim 1, wherein a correct label is appended to each of the items of data contained in the second data set based on a classification result by the classification model for each of the items of data contained in the second data set, and an error between the classification result by the classification model for each of the items of data contained in the second data set and the correct label is computed as the loss.

8. An information processing device comprising:
a memory; and
a processor coupled to the memory, the processor being configured to execute processing, the processing comprising:
for a classification model for classifying input data into one or another of a plurality of classes that was trained using a first data set, identifying, in a second data set that is different from the first data set, one or more items of data having a specific datum of which a degree of contribution to a change in a classification criterion is greater than a predetermined threshold, the classification criterion being a classification criterion of the classification model during re-training based on the second data set; and
from among the one or more items of data, detecting an item of data, for which a loss reduces for the classification model by change to the classification criterion by re-training based on the second data set, as an item of data of an unknown class not contained in the plurality of classes.

9. The information processing device of claim 8, wherein the classification criterion is a weight to identify a decision plane indicating a boundary between classes in the classification model.

10. The information processing device of claim 8, wherein, a movement distance, when each of the items of data contained in the second data set is moved so as to reduce an update value of the classification criterion of the classification model during re-training based on the second data set, is computed as the degree of contribution.

11. The information processing device of claim 8, wherein an item of data having a positive increase amount of the loss when each of the one or more items of data is moved in a direction to suppress change of the classification criterion by re-training based on the second data set is detected as the item of data of an unknown class.

12. The information processing device of claim 10, wherein, when the classification model is a differentiable model, a magnitude of a first gradient of the classification criterion with respect to the loss is computed as the update value, and a magnitude of a second gradient of each of the items of data contained in the second data set with respect to the magnitude of the first gradient is computed as the movement distance.

13. The information processing device of claim 12, wherein an item of data having a positive inner product between the second gradient and a third gradient of each of the one or more items of data with respect to the loss is detected as being the item of data of an unknown class.

14. The information processing device of claim 8, wherein a correct label is appended to each of the items of data contained in the second data set based on a classification result by the classification model for each of the items of data contained in the second data set, and an error between the classification result by the classification model for each of the items of data contained in the second data set and the correct label is computed as the loss.

15. An information processing method comprising:
by a processor,
for a classification model for classifying input data into one or another of a plurality of classes that was trained using a first data set, identifying, in a second data set that is different from the first data set, one or more items of data having a specific datum of which a degree of contribution to a change in a classification criterion is greater than a predetermined threshold, the classification criterion being a classification criterion of the classification model during re-training based on the second data set; and
from among the one or more items of data, detecting an item of data, for which a loss reduces for the classification model by change to the classification criterion by re-training based on the second data set, as an item of data of an unknown class not contained in the plurality of classes.

16. The information processing method of claim 15, wherein the classification criterion is a weight to identify a decision plane indicating a boundary between classes in the classification model.

17. The information processing method of claim 15, wherein a movement distance, when each of the items of data contained in the second data set is moved so as to reduce an update value of the classification criterion of the classification model during re-training based on the second data set, is computed as the degree of contribution.

18. The information processing method of claim 15, wherein an item of data having a positive increase amount of the loss when each of the one or more items of data is moved in a direction to suppress change of the classification criterion by re-training based on the second data set is detected as the item of data of an unknown class.

19. The information processing method of claim 17, wherein, when the classification model is a differentiable model, a magnitude of a first gradient of the classification criterion with respect to the loss is computed as the update value, and a magnitude of a second gradient of each of the items of data contained in the second data set with respect to the magnitude of the first gradient is computed as the movement distance.

20. The information processing method of claim 19, wherein an item of data having a positive inner product between the second gradient and a third gradient of each of the one or more items of data with respect to the loss is detected as being the item of data of an unknown class.
